(19) United States
(12) Patent Application Publication
(10) Pub. No.: US 2008/0206611 A1
(43) Pub. Date: Aug. 28, 2008

(54) Fuel Cell System and Control Method Thereof

(76) Inventors: Riki Otsuka, Aichi-ken (JP); Takuo Yanagi, Aichi-ken (JP); Munetoshi Kuroyanagi, Aichi-ken (JP)

Correspondence Address: KENYON & KENYON LLP, 1500 K STREET N.W., SUITE 700, WASHINGTON, DC, 20005, US

(21) Appl. No.: 10/577,019

(22) PCT Filed: Oct. 19, 2004
(86) PCT No.: PCT/IB04/03412

§ 371 Date: Apr. 25, 2006

(30) Foreign Application Priority Data
Oct. 27, 2003 (JP) 2003-366384

(51) Int. Cl. H01M 8/06; H01M 8/04

(52) U.S. Cl. 429/17; 429/34; 429/20

(57) ABSTRACT

A fuel cell system includes a fuel cell (10), a supply passage (11) through which fuel gas and oxidizing gas are supplied to the fuel cell, an exhaust passage (12) through which the fuel gas and the oxidizing gas are discharged from the fuel cell, and a reactor (13) provided in the exhaust passage (12) such that a fuel off-gas from the fuel cell is oxidized. The fuel cell system further includes a bypass passage (14) that extends from the supply passage (11) to reach the reactor (13) and returns to the supply passage (11) such that at least a portion of the fuel gas and the oxidizing gas supplied to the fuel cell upon activation thereof is supplied to the bypass passage 14 and heated in the reactor (13). The bypass passage (14) is communicated with an inside of the reactor (13) such that the gas is heated and humidified under a reaction in the reactor (13) upon activation of the fuel cell.

This is a 371 national phase application of PCT/IB2004/003412 filed 19 Oct. 2004, claiming priority to Japanese Patent Application No. 2003-366384 filed 27 Oct. 2003, the contents of which are incorporated herein by reference.

### BACKGROUND OF THE INVENTION

1. Field of Invention

The invention relates to a fuel cell system, and particularly to a fuel cell system that allows early activation of the fuel cell.

2. Description of Related Art

A fuel cell (FC) is formed by stacking an electrolyte, an MEA including an anode provided on one surface of the electrolyte and a cathode provided on the other surface of the electrolyte, and a separator. The anode receives supply of fuel gas (normally, gas that contains hydrogen), and the cathode receives supply of oxidizing gas (gas that contains oxygen or normally air) such that power is generated by the fuel cell. The fuel gas is used for generating power, and the fuel gas discharged from the fuel cell is circulated into a fuel gas supply system via a pump. As a small amount of nitrogen is mixed with the fuel gas through the electrolyte from the cathode during power generation, the discharged fuel gas is oxidized, which is discharged into atmosphere intermittently.

It is necessary to hold the fuel cell at a predetermined temperature and to humidify the supplied gas constantly for the purpose of stable power generation performed by the fuel cell. However, the temperature of the fuel cell upon activation is low, and accordingly it will take time for the temperature to be heated enough to allow the stable power generation. Moreover, as the gas to be supplied to the fuel cell has not been humidified yet upon activation, the power generation at this stage is not stable yet. It may take time for the fuel cell to be activated for the aforementioned reasons.

Japanese Patent Application Laid-Open No. JP-A-2001-155754 discloses that a combustion chamber is provided in the anode and the cathode, respectively for heating the fuel gas and air with the combustion heat generated in the respective combustion chambers upon activation of the fuel cell so as to accelerate the activation at an earlier stage. The fuel gas and air discharged from the fuel cell are completely burned in the exhaust combustion portion. As the fuel cell system as aforementioned requires the combustion chambers to be provided for the anode and the cathode of the fuel cell, respectively, it is difficult to reduce the size of the aforementioned system.

Those combustion chambers employed for the anode and cathode of the fuel cell in order to accelerate activation thereof may prevent the size of the fuel cell system from being reduced.

### SUMMARY OF THE INVENTION

It is an object of the invention to provide a compact fuel cell system that requires no heating unit for heating the fuel gas and oxidizing gas for the purpose of early activation of the fuel cell.

(1) According to the invention, a fuel cell system includes a fuel cell, a supply passage through which a fuel gas and an oxidizing gas is supplied to the fuel cell, and an exhaust passage through which the fuel gas and the oxidizing gas flow from the fuel cell, and a reactor that is provided in the exhaust passage and oxidizes a fuel off-gas from the fuel cell. The fuel cell system further includes a bypass passage that extends from the supply passage to reach the reactor and returns to the supply passage, which receives a flow of at least a portion of the fuel gas and the oxidizing gas to be supplied to the fuel cell upon activation thereof so as to be heated under a heat generated in the reactor. The above described characteristic of the fuel cell system applies to all embodiments of the invention as described below.

(2) In the fuel cell system according to the invention, the bypass passage includes at least one of a fuel gas bypass passage and an oxidizing gas bypass passage, the fuel gas bypass passage is branched from the supply passage through which the fuel gas is supplied to the fuel cell to pass through the reactor and return to the supply passage such that a hydrogen rich gas flows therethrough, the oxidizing gas bypass passage is branched from the supply passage through which the oxidizing gas is supplied to the fuel cell (10) to pass through the reactor and return to the supply passage such that an oxygen rich gas flows therethrough. The above described characteristic of the fuel cell system applies to all embodiments of the invention as described below.

(3) In the fuel cell system according to the invention, the reactor includes at least one of a first reactor that allows the hydrogen rich gas to flow from the reactor into an anode of the fuel cell upon activation thereof, a second reactor that allows the oxygen rich gas to flow from the reactor into a cathode of the fuel cell. The above described characteristic of the fuel cell system applies to all embodiments of the invention as described below.

(3) The fuel cell system according to the invention further includes valves in the bypass passage and in the supply passage through which the fuel gas and the oxidizing gas are supplied to the fuel cell. In the fuel cell system, the valves are operated to select a state between a first state where at least a portion of the fuel gas and the oxidizing gas supplied to the fuel cell upon activation thereof passes through the bypass passage and the reactor, and a second state where at least a portion of the fuel gas and the oxidizing gas discharged from the fuel cell during a normal operation after the activation of the fuel cell passes through the reactor. The above described characteristic of the fuel cell system applies to all embodiments of the invention as described below.

(5) In the fuel cell system according to the invention, a gas supplied to the reactor upon activation of the fuel cell is identical to a gas to be supplied to a gas inlet of the fuel cell during a normal operation thereof. The above described characteristic of the fuel cell system applies to all embodiments of the invention as described below.

(6) In the fuel cell system according to the invention, the bypass passage is communicated with an inside of the reactor such that the gas flowing into the reactor upon activation of the fuel cell is heated and humidified in a reaction generated in the reactor and supplied to the fuel cell. The above described characteristic of the fuel cell system applies to embodiments 1 to 4 of the invention as described below.

(7) In the fuel cell system according to the invention, the bypass passage includes a fuel gas bypass passage and an oxidizing gas bypass passage. The reactor includes a first reactor that discharges the hydrogen rich gas so as to flow into the anode of the fuel cell upon activation thereof, and a second reactor that discharges the oxygen rich gas so as to flow into the cathode of the fuel cell upon activation thereof. The valve provided in the supply passage through which the fuel gas and the oxygen gas are supplied to the fuel cell is structured as an on-off valve that allows a whole quantity of the fuel gas to flow into the first reactor and a whole quantity of the oxidizing gas into the second reactor upon activation of the fuel cell. The above described characteristic of the fuel cell system applies to the embodiment 1 of the invention.

(8) In the fuel cell system according to the invention, the bypass passage includes the fuel gas bypass passage and the oxidizing gas bypass passage. The reactor includes the first reactor that discharges the hydrogen rich gas so as to flow into the anode of the fuel cell upon activation thereof, and the second reactor that discharges the oxygen rich gas so as to flow into the cathode of the fuel cell upon activation thereof. The valve provided in the supply passage through which the fuel gas and the oxygen gas are supplied to the fuel cell is structured as a flow control valve that allows a portion of the fuel gas to flow into the first reactor, and a portion of the oxidizing gas to flow into the second reactor upon activation of the fuel cell. The above described characteristic of the fuel cell system applies to the embodiment 2 of the invention.

(9) In the fuel cell system according to the invention, the bypass passage includes an oxidizing gas bypass passage. The reactor includes the second reactor that discharges the oxygen rich gas to flow into the cathode of the fuel cell upon activation thereof. The valve provided in the supply passage through which the oxidizing gas is supplied to the fuel cell allows at least a portion of the oxidizing gas to flow into the second reactor upon activation of the fuel cell. The above described characteristic of the fuel cell system applies to the embodiment 3 of the invention as described below.

(10) In the fuel cell system according to the invention, the bypass passage includes a fuel gas bypass passage. The reactor includes the first reactor that discharges the hydrogen rich gas to flow into the anode of the fuel cell upon activation thereof. The valve provided in the supply passage through which the fuel gas is supplied to the fuel cell allows at least a portion of the fuel gas to flow into the first reactor upon activation of the fuel cell. The above described characteristic of the fuel cell system applies to the embodiment 4 of the invention as described below.

(11) In the fuel cell system according to the invention, the bypass passage is arranged to be outside of the reactor so as not to be communicated with the inside of the reactor, and structured such that the heat is exchangeable between the bypass passage and the inside of the reactor. The above described characteristic of the fuel cell system applies to the embodiment 5.

(12) In a method of controlling a fuel cell system as described in (1), at least a portion of the fuel gas and the oxidizing gas to be supplied to the fuel cell is fed into the bypass passage upon activation of the fuel cell so as to be heated under a heat generated in the reactor.

According to the fuel cell system as aforementioned, the reactor functions in treating the fuel off-gas and generating heat applied to the fuel cell upon activation thereof. The heat source for activating the fuel cell does not have to be provided, thus reducing the size of the fuel cell system. Each of the fuel cell systems as described in (2) to (5) is an embodiment of the fuel cell system described in (1).

In the fuel cell system according to (6), the gas from the reactor contains moisture generated by combustion of the fuel gas, which is supplied to the fuel cell. This makes it possible to heat and humidify the gas to be supplied to the fuel cell at the earlier stage simultaneously. The heated and humidified gas may be supplied to the fuel cell at the earlier stage, thus allowing acceleration of the fuel cell activation.

Each of the fuel cell systems described in (7) to (10) is an embodiment of the fuel cell system of (6). The respective fuel cell systems (7) to (10) correspond to the embodiments 1 to 4 according to the invention. As the fuel cell system described in (8) includes a flow control valve, the air/fuel ratio upon activation of the fuel cell may be held within the stable combustion, thus stabilizing the hydrogen combustion.

The fuel cell system described in (11) makes it possible to reduce the cost compared with the fuel cell system described in (6).

The method described in (12) is employed for executing a control of activating the fuel cell system described in (1). This makes it possible to allow early activation of the fuel cell system.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a schematic view that represents a structure of a fuel cell system according to an embodiment 1;

FIG. 2 is a schematic view that represents a structure of the fuel cell system upon activation thereof according to the embodiment 1;

FIG. 3 is a schematic view that represents a structure of the fuel cell system during normal operation according to the embodiment 1;

FIG. 4 is a schematic view that represents a structure of a fuel cell system according to an embodiment 2;

FIG. 5 is a schematic view that represents a structure of a fuel cell system according to an embodiment 3;

FIG. 6 is a schematic view that represents a structure of a fuel cell system according to an embodiment 4; and

FIG. 7 is a schematic view that represents a structure of a fuel cell system according to an embodiment 5.

### DETAILED DESCRIPTION OF PREFERRED EMBODIMENT

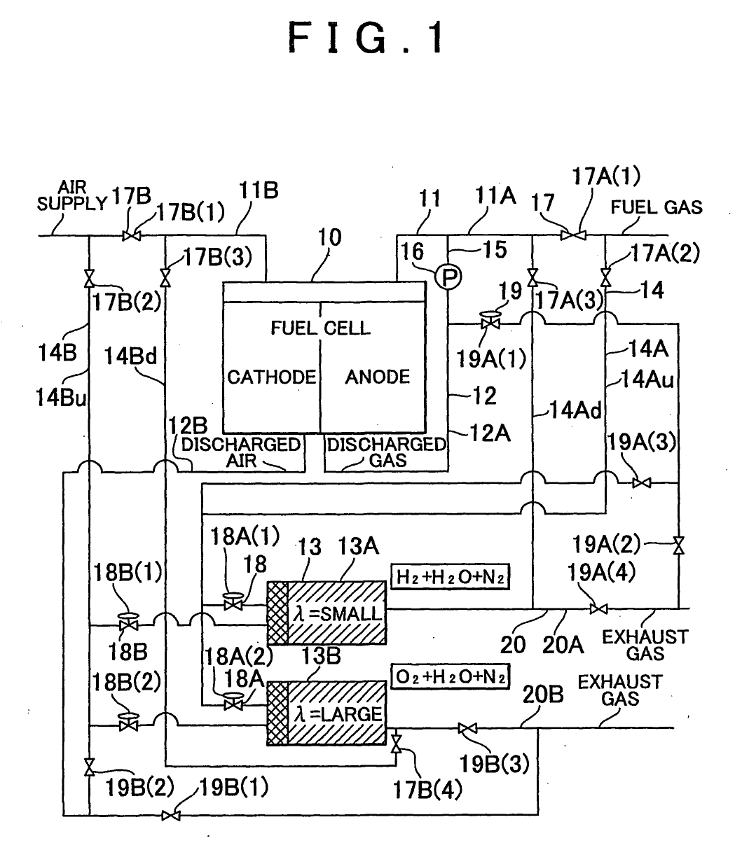

A fuel cell system of the invention will be described referring to FIGS. 1 to 7.

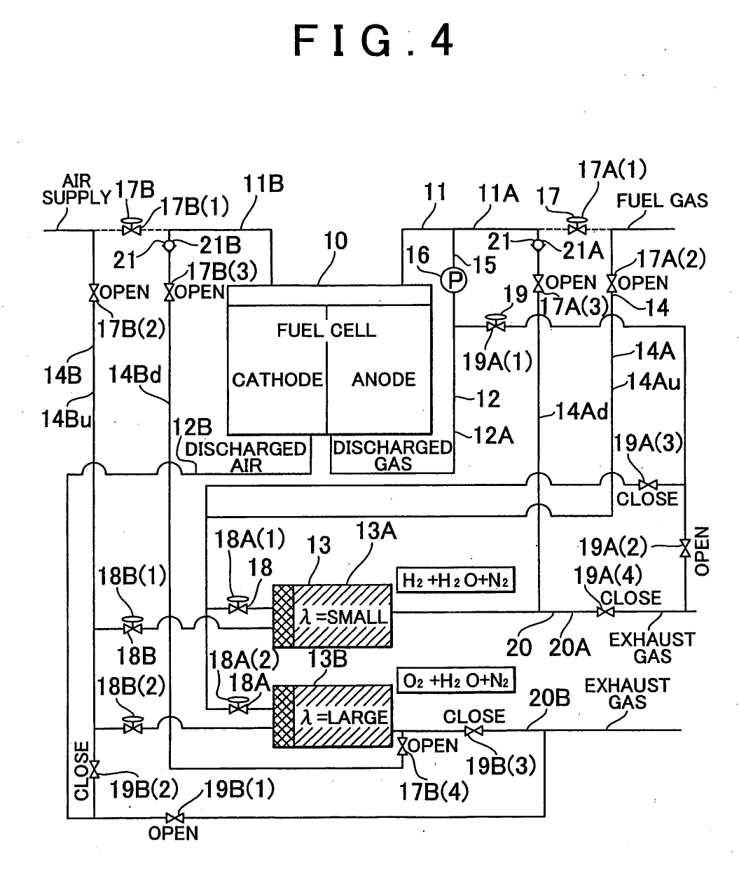

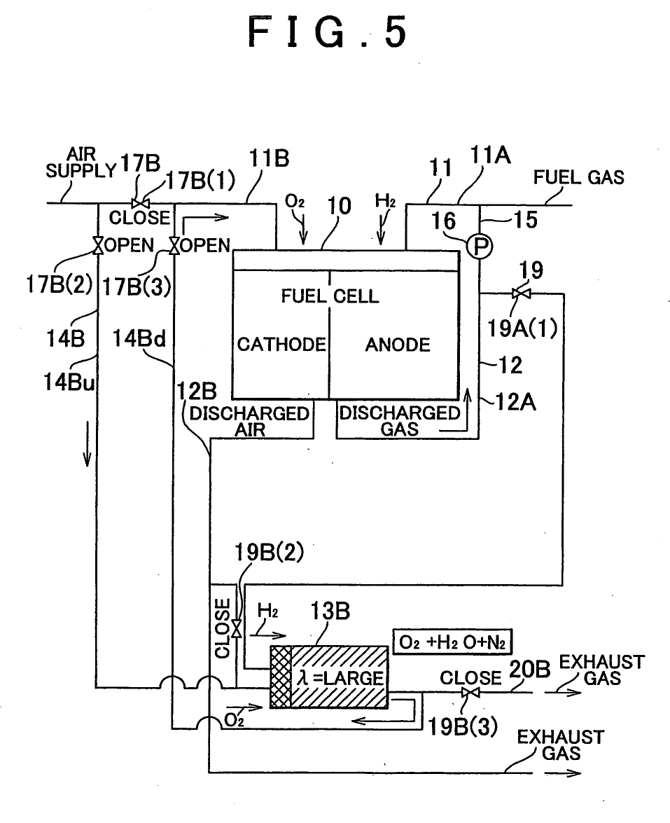

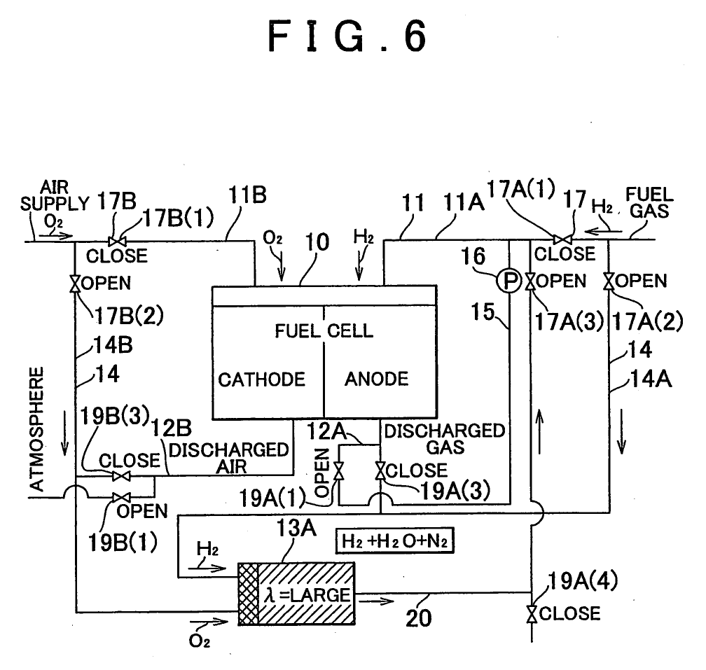

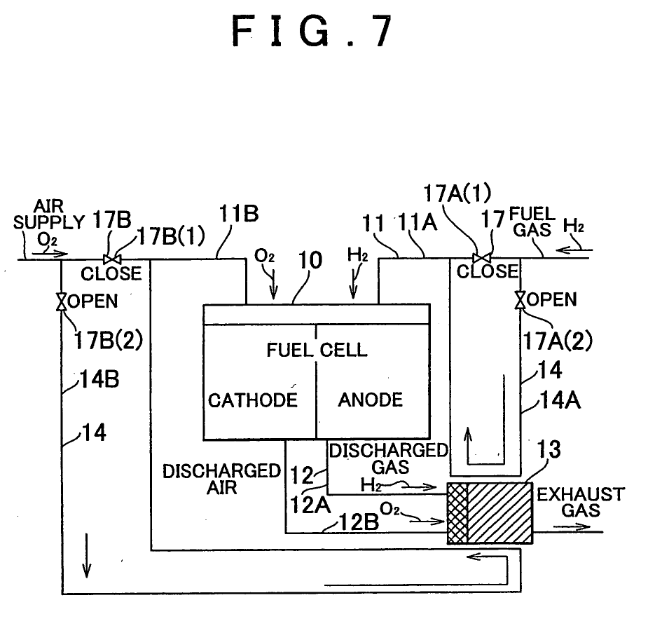

FIGS. 1 to 3 represent an embodiment 1 of the invention, FIG. 4 represents an embodiment 2, FIG. 5 represents an embodiment 3, FIG. 6 represents an embodiment 4, and FIG. 7 represents an embodiment 5, respectively.

The embodiments 1 to 4 are categorized as a first group of the invention. In the embodiments of the first group, the gas to be supplied to the fuel cell is humidified in the reactor. The embodiment 5 is categorized as a second group of the invention. In the embodiment of the second group, the gas to be supplied to the fuel cell is not humidified in the reactor. The elements identical or similar to those in the embodiments will be designated with the same reference numerals.

Referring to FIG. 1, the identical or similar features among all the embodiments of the invention will be described.

A fuel cell system of the invention includes a fuel cell 10, a supply passage 11 through which the fuel gas and oxidizing gas are supplied to the fuel cell 10, an exhaust passage 12 through which the fuel gas and the oxidizing gas from the fuel cell 10 is discharged, and a reactor 13 provided in the exhaust passage 12 for oxidizing the fuel off-gas from the fuel cell 10. The fuel cell system further includes a bypass passage 14 that extends from the supply passage 11 to the reactor 13, and returns to the supply passage 11 therefrom. The fuel cell system of the invention further includes a passage 20 (discharge hydrogen passage 20A, discharge air passage 20B) to the secondary side of the reactor 13 from discharge hydrogen and air lines, respectively.

In the fuel cell system according to the invention, at least a portion of the fuel gas and the oxidizing gas to be supplied to the fuel cell 10 upon activation thereof is fed into the bypass passage 14 so as to be heated with the heat generated in the reactor 13.

The bypass passage 14 connected to the reactor 13 may be formed separately from or commonly used as the exhaust passage. It is preferable to make a part of the bypass passage commonly used as the exhaust passage so as to simplify and reduce the size of the fuel cell system.

The fuel cell 10 is of solid polymer electrolyte type, for example, as a stack body formed of an MEA (Membrane-Electrode Assembly) including an electrolyte, an anode formed on one surface of the electrolyte, and a cathode formed on the other surface of the electrolyte, and a separator. The MEA and the separator are stacked in an arbitrary direction that is not limited to the vertical direction. The fuel gas contains hydrogen, and the oxidizing gas contains oxygen, for example, air.

The reactor 13 is provided with an oxidizing catalyst for oxidizing the fuel gas. However, an absorption catalyst may be provided in the reactor 13. The term “oxidizing” may include combustion. The fuel gas absorbed by the absorption catalyst is oxidized through the oxidizing catalyst, and burned under the heat generated upon combustion so as to be removed.

The “return of the bypass passage 14 to the supply passage 11” in the embodiments of the invention includes the direct flow of the gas into the fuel cell 10. The term “bypass” used for describing the bypass passage 14 stands for the operation of bypassing the passage portion between the branch point of the supply passage 11 to the bypass passage 14 and the return point therefrom. In other words, the bypass passage 14 extends from the supply passage 11 to the reactor 13, and then returns to the fuel cell 10.

The supply passage 11 through which the fuel gas and the oxidizing gas are supplied to the fuel cell 10 includes a supply passage 11A through which the fuel gas is supplied to the fuel cell 10, and a supply passage 11B through which the oxidizing gas is supplied to the fuel cell 10.

The exhaust passage 12 through which the fuel gas and the oxidizing gas are discharged from the fuel cell 10 includes an exhaust passage 12A through which the fuel gas is discharged from the fuel cell 10, and an exhaust passage 12B through which the oxidizing gas is discharged from the fuel cell 10.

The exhaust passage 12A through which the fuel gas is discharged from the fuel cell 10 is provided with a circulation passage 15 through which the fuel gas is circulated to the supply passage 11A. The circulation passage 15 is provided with a pump 16 that serves to return hydrogen which passes through the exhaust passage 12A to the supply passage 11A.

As a small amount of nitrogen contained in the oxidizing gas is mixed with the fuel gas through the electrolyte during operation of the fuel cell, the fuel gas is discharged into atmosphere at a predetermined interval so as to remove the nitrogen. The passage for discharging the fuel gas into atmosphere is provided with the reactor 13 for burning the hydrogen before it is discharged into atmosphere so as to prevent direct discharge of the combustible gas into atmosphere.

The bypass passage 14 includes at least one of a fuel gas bypass passage 14A and an oxidizing gas bypass passage 14B. The fuel gas bypass passage 14A is branched from the supply passage 11A at a branch point to extend through the reactor 13 and return to the fuel gas supply passage 11A, through which hydrogen rich gas flows. The oxidizing gas bypass passage 14B is branched from the supply passage 11B at a branch point to extend through the reactor 13 and return to the supply passage 11B, through which oxygen rich gas flows.

The bypass passage 14 that has not been employed in the general fuel cell system makes it possible to allow the reactor 13 to function in heating and/or humidifying the gas to be supplied. The fuel gas bypass passage 14A includes an upstream fuel gas bypass passage 14Au upstream of the reactor 13 and a downstream fuel gas bypass passage 14Ad downstream of the reactor 13.

The oxidizing gas bypass passage 14B includes an upstream oxidizing gas bypass passage 14Bu upstream of the reactor 13 and a downstream oxidizing gas bypass passage 14Bd downstream of the reactor 13.

The reactor 13 includes at least one of a first reactor 13A that flows the hydrogen rich gas to the anode side of the fuel cell 10 upon activation thereof, and a second reactor 13B that flows the oxygen rich gas to the cathode side of the fuel cell upon activation of the fuel cell.

The first reactor 13A is operated at a small air/fuel ratio λ, and the second reactor 13B is operated at a large air/fuel ratioλ.

The first reactor 13A discharges H₂, H₂O, and N₂, and the second reactor 13B discharges O₂, H₂O and N₂.

When the gas discharged from the first reactor 13A is mixed with the fuel gas that passes through the supply passage 11A and the mixture is supplied to the fuel cell, the temperature of the mixture becomes 80° C. or higher (the temperature of the gas discharged from the first reactor 13A is higher than that of the mixture).

When the gas discharged from the second reactor 13B is mixed with the fuel gas that passes through the oxidizing gas supply passage 11B and the mixture is supplied to the fuel cell, the temperature of the mixture becomes 80° C. or higher (the temperature of the gas discharged from the second reactor 13B is higher than the mixture).

There are valves 17 provided in the bypass passage 14 and the supply passage 11. The valve 17 serves to select the state between a first state where at least a portion of the fuel gas and the oxidizing gas to be supplied to the fuel cell 10 upon activation is allowed to pass through the bypass passage 14 and the reactor 13, and a second state where at least a portion of the fuel gas and the oxidizing gas discharged from the fuel cell 10 during normal operation after activation of the fuel cell is allowed to pass through the reactor 13.

The valve 17 provided in the fuel gas bypass passage 14A and the supply passage 11 includes valves 17A(1), 17A(2), and 17A(3). The valve 17A(1) is provided between the branch point in the supply passage 11A to the bypass passage 14A and a return joint point. The valve 17A(2) is provided in the upstream fuel gas bypass passage 14Au. The valve 17A(3) is provided in the downstream fuel gas bypass passage 14Ad.

The valve 17 provided in the oxidizing gas bypass passage 14B and the supply passage 11 includes valves 17B(1), 17B(2), 17B(3), and 17B(4). The valve 17B(1) is provided between the branch point in the supply passage 11B to the bypass passage 14B and the return joint portion. The valve 17B(2) is provided in the upstream oxidizing gas bypass passage 14Bu. The valve 17B(3) is provided in the downstream oxidizing gas bypass passage 14Bd. The valve 17B(4) is provided at the portion just downstream of the branch portion in the downstream oxidizing gas bypass passage 14Bd with respect to the exhaust passage 12B. Provision of the valve 17B(4), however, is not necessary.

The valve 17 may be structured as a shut valve (on-off valve) or a flow control valve. The control for operation of the valve 17 or of the opening degree of the valve 17 is executed upon command of the operation control unit for the fuel cell (computer provided in the vehicle). The aforementioned control is executed in accordance with the operation of the fuel cell (upon activation or during normal operation after the activation).

A flow control valve 18 is provided in the bypass passage 14. The flow control valve 18 functions in selecting the flow rate ratio with respect to the fuel gas (hydrogen) and the oxidizing gas (air) each flowing into the reactor 13 between a small value and a large value so as to adjust the air/fuel ratio A in the first and the second reactors 13A and 13B, respectively.

The flow control valve 18 includes flow control valves 18A(1), 18A(2), 18B(1), and 18B(2). The flow control valve 18A(1) is provided around an inlet of the fuel gas bypass passage 14A to the first reactor 13A. The flow control valve 18A(2) is provided around an inlet of the fuel gas bypass passage 14A to the second reactor 13B. The flow control valve 18B(1) provided around an inlet of the oxidizing gas bypass passage 14B to the first reactor 13A. The flow control valve 18B(2) is provided around an inlet of the oxidizing gas bypass passage 14B to the second reactor 13B.

A valve 19 is provided in the exhaust passage 12 through which the fuel gas and the oxidizing gas from the fuel cell 10 flow. The valve 19 may be structured as the on-off valve. The valve 19 includes valves 19A(1), 19A(2), 19A(3), and 19A(4) each provided in the exhaust passage 12A through which the fuel gas from the fuel cell 10 flows. The valve 19A(1) is provided at a position just downstream of the portion at which the circulation passage 15 of the exhaust passage 12A is branched. The valve 19A(2) is provided at a position just upstream of the portion at which the branch passage from the first reactor 13(A) in the exhaust passage 12A is joined. The valve 19A(3) is provided upstream of the first reactor 13(A) in the branch passage to the reactor 13. The valve 19A(4) is provided downstream of the first reactor 13(A) in the branch passage thereto.

The valve 19 further includes valves 19B(1), 19B(2), and 19B(3) each provided in the exhaust passage 12B through which the oxidizing gas from the fuel cell 10 flows. The valve 19B(1) is provided downstream of the position at which the branch passage of the exhaust passage 12B to the reactor 13 is branched. The valve 19B(2) is provided upstream of the second reactor 13(B) in the branch passage to the reactor 13. The valve 19B(3) is provided downstream of the second reactor 13(B) in the branch passage thereto.

The gas to be supplied to the reactor 13 upon activation of the fuel cell is identical to the one supplied to a gas inlet of the fuel cell during normal operation thereof. The oxidizing gas supplied to the reactor 13 upon activation of the fuel cell may be used as secondary air separately from air to be supplied to the gas inlet of the fuel cell during normal operation thereof.

In the respective embodiments (1 to 4) categorized as the first group of the invention, the bypass passage 14 is communicated with inside of the reactor 13. Accordingly the gas (hydrogen and air) to be fed into the reactor 13 upon activation of the fuel cell 10 is heated under the reaction (oxidizing hydrogen by air) in the reactor 13, and humidified by moisture generated by the reaction.

The function and effect of the embodiments of the invention will be described.

Under the normal operation of the fuel cell 10 after the activation, the fuel off-gas is reacted with air (oxidized off-gas or independently supplied secondary air) in the reactor 13 provided in the exhaust passage 12 so as to be discharged into atmosphere as the gas containing no hydrogen. Upon activation of the fuel cell 10, the fuel gas and air (oxidized off-gas from the fuel cell 10 or independently supplied secondary air) are supplied to the reactor 13, and the fuel gas and air heated under the heat generated by oxidizing reaction of hydrogen are supplied to the fuel cell 10 so as to be activated at the earlier stage. The reactor 13 provided for combustion of the fuel off-gas functions in treating the fuel-off gas discharged from the fuel cell and serving as the heat source for the purpose of early activation of the fuel cell. Therefore, the heat source (combustor and the like) exclusively used for activating the fuel cell does not have to be provided. The invention makes it possible to provide the compact fuel cell system while allowing early activation.

In the case where two reactors are provided, that is, the first reactor 13A connected to the anode side, and the second reactor 13B connected to the cathode side, the first reactor 13A is operated at a small air/fuel ratio λ, and the second reactor 13B is operated at a large air/fuel ratioλupon activation of the fuel cell. The thus heated fuel gas that contains no oxygen and the heated oxidizing gas that contains no hydrogen may be supplied to the fuel cell 10 upon activation thereof. A hydrogen sensor and an oxygen sensor may be provided in the gas passage so as to execute the feedback control under which each flow rate of the fuel gas and the oxidizing gas is selected in case of necessity. This makes it possible to execute further accurate activation control.

The shut valves are used for the valves 17A(1) and 17B(1) such that the whole quantity of the gas may be supplied to the reactor 13. The use of the flow control valve allows a portion of the gas (appropriate quantity) to be supplied to the reactor 13. If the flow control valve is used for the valves 17A(1) and 17B(1) so as to partially supply air to the reactor 13, the combustion within the reactor 13 may be performed at the air/fuel ratioλwithin the stable combustion range, thus stabilizing combustion of the hydrogen.

In the embodiments 1 to 4 categorized as the first group of the invention, the gas from the reactor 13 contains moisture generated in the combustion of the fuel gas (H₂), which is supplied to the fuel cell 10. The gas supplied to the fuel cell can be not only heated at an earlier stage but also humidified simultaneously. This makes it possible to bring the fuel cell into the stable operation range at the earlier stage.

The specific feature of the respective embodiments of the invention will be described.

### Embodiment 1

In the embodiment 1 of the invention as shown in FIGS. 1 to 3, the bypass passage 14 includes the fuel gas bypass passage 14A and the oxidizing gas bypass passage 14B. The reactor 13 includes the first reactor 13A that discharges the hydrogen rich gas so as to be fed to the anode side of the fuel cell upon activation thereof, and the second reactor 13B that discharges the oxygen rich gas so as to be fed to the cathode side of the fuel cell upon activation thereof. The shut valve or on-off valve is used for the valves 17A(1) and 17B(1) provided in the supply passages 11A, 11B through which the fuel gas and the oxidizing gas are supplied to the fuel cell 10, respectively. Each of the valves 17A(1) and 17B(1) is selectively operated so as to feed the whole quantity of the fuel gas to the first reactor 13A, and feed the whole quantity of the oxidizing gas to the second reactor 13B.

In this case, the valves 17A(2), 17A(3), 18A(1), 18A(2), and 19A(2) are opened, and the valves 17A(1), 19A(3), 19A(4) are closed upon activation. Further the valves 17B(2), 17B(3), 17B(4), 18B(1), 18B(2), and 19B(1) are opened, and the valves 17B(1), 19B(2), and 19B(3) are closed.

During normal operation, the valves 17A(2), 17A(3), 19A(2) are closed, and the valves 17A(1), 19A(3), 19A(4), 18A(1), and 18A(2) are opened. Further the valves 17B(2), 17B(3), 17B(4), and 19B(1) are closed, and the valves 17B(1), 19B(2), 19B(3), 18B(1), and 18B(2) are opened.

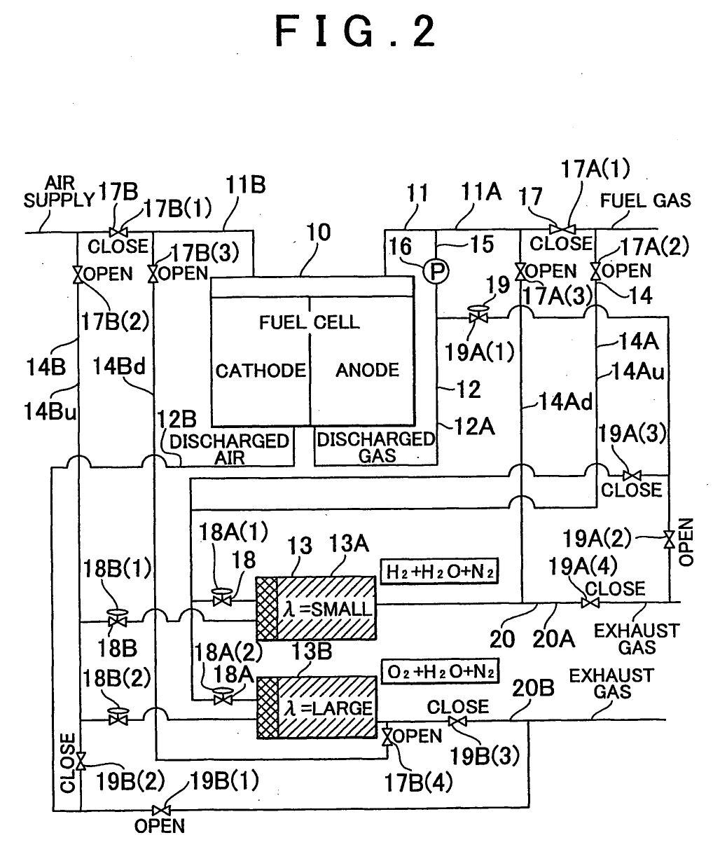

Referring to FIG. 2, upon activation of the fuel cell, the valve 17A(1) is closed such that the whole quantity of the supplied fuel gas is fed to the first reactor 13A in which the fuel gas is burned and heated at the small air/fuel ratioλ, and the fuel gas is also humidified by the moisture generated in the combustion so as to be supplied to the anode side of the fuel cell 10. Likewise the valve 17B(1) is closed such that the whole quantity of the supplied oxidizing gas is fed to the second reactor 13B in which the fuel gas is burned and heated at the large air/fuel ratioλ, and the oxidizing gas is also humidified by the moisture generated in the combustion so as to be supplied to the cathode side of the fuel cell 10. This makes it possible to activate the fuel cell 10 at the earlier stage as well as to humidify the fuel cell 10.

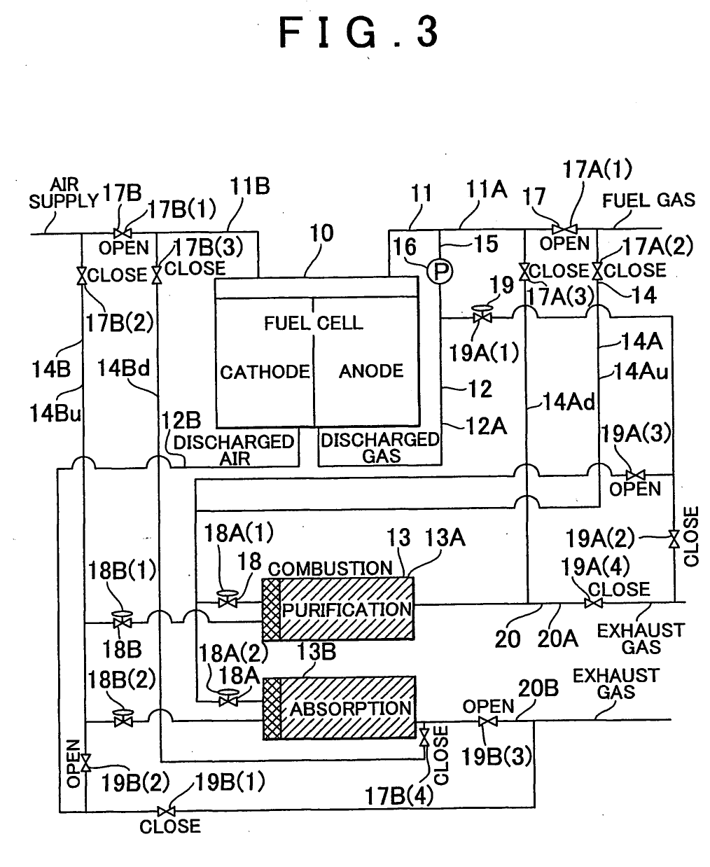

Referring to FIG. 3, during the normal or steady operation, the valve 17A(1) is opened as shown in FIG. 3 such that the whole quantity of the supplied fuel gas is fed to the anode side of the fuel cell, and the valve 17B(1) is opened such that the whole quantity of the supplied oxidizing gas is directly fed to the cathode side of the fuel cell. The discharged fuel gas is intermittently supplied to the first reactor 13A for discharging nitrogen. The discharged oxidizing gas is constantly supplied to the second reactor 13B such that the discharged hydrogen and so called odor content are absorbed. Combustion is performed alternatively in the first reactor 13A and the second reactor 13B so as to remove the absorbed hydrogen and odor content through combustion. The heat generated in the catalytic combustion of the discharged hydrogen is used for the aforementioned combustion.

### Embodiment 2

In the embodiment 2 of the invention, the flow control valve is used for the valves 17A(1) and 17B(1) provided in the supply passages 11A, 11B as shown in FIG. 4. There are check valves 21A, 21B (one-way valve that interrupts the flow of the gas from the supply passages 11A, 11B to the reactors 13A, 13B, respectively) just downstream of the valves 17A(3), 17B(3). Other structure is the same as that of the embodiment 1 of the invention.

As the flow control valve is used for the valves 17A(1) and 17B(1), the ratio of each flow rate of the fuel gas and the oxidizing gas directly fed to the fuel cell 10 with respect to that of the gas fed to the fuel cell 10 via the reactor 13 may be changed. As a result, the hydrogen may be oxidized (burned) within the reactors 13A, 13B at the air/fuel ratioλ in the stable combustion range. Other functions and effects of the embodiment are the same as those of the embodiment 1.

### Embodiment 3

In the embodiment 3 of the invention, the bypass passage 14 includes only the oxidizing gas bypass passage 14B with no fuel gas bypass passage 14A as shown in FIG. 5. The reactor 13 includes only the second reactor 13B that discharges the oxygen rich gas upon activation so as to be fed to the cathode side of the fuel cell. The valve 17B(1) provided in the supply passage 11B through which the oxidizing gas is supplied to the fuel cell serves to feed at least a portion of the oxidizing gas (including a portion of the gas and the whole quantity of the gas) to the second reactor 13B upon activation of the fuel cell. In the case where only a portion of the oxidizing gas is fed to the second reactor 13B upon activation of the fuel cell, the valve 17B(1) is structured as the flow control valve. In the case where the whole quantity of the oxidizing gas is fed to the second reactor 13B upon activation of the fuel cell, the valve 17B(1) is structured as the on-off or shut valve.

Functions and effects of the embodiment 3 are the same as those of the embodiment 1 with respect to the oxidizing gas.

### Embodiment 4

In the embodiment 4 of the invention, the bypass passage 14 includes only the fuel gas bypass passage 14A with no oxidizing gas bypass passage 14B as shown in FIG. 6. The reactor 13 includes only the first reactor 13A that discharges the hydrogen rich gas upon activation of the fuel cell so as to be fed to the anode side of the fuel cell. The valve 17A(1) provided in the supply passage 11A to the fuel cell serves to feed at least one portion of the fuel gas (including only a portion of the fuel gas and the whole quantity of the fuel gas) to the first reactor 13A upon activation of the fuel cell. In the case where a portion of the fuel gas is fed to the first reactor 13A upon activation, the valve 17A(1) is structured as the flow control valve. In the case where the whole quantity of the fuel gas is fed to the first reactor 13A upon activation, the valve 17A(1) is structured as the on-off or shut valve.

Functions and effects of the embodiment 4 are the same as those of the embodiment 1 with respect to the fuel gas.

### Embodiment 5

In the embodiment 5 of the invention, the bypass passage 14 (the fuel gas bypass passage 14A and/or oxidizing gas bypass passage 14B) is arranged outside of the reactor 13 so as not to be communicated with the inside of the reactor 13 but heat exchangeable with the inside thereof.

According to the embodiment 5 of the invention, as the gas passing through the bypass passage 14 does not pass through the inside of the reactor 13, the oxidation with hydrogen and oxygen, and combustion do not occur. As no moisture is generated, the gas is not humidified. However, the discharged fuel gas is oxidized, and the resultant heat is used to heat the supplied gas in the course of heat exchange in the reactor. The supplied gas, thus, can be heated. Other functions and effects are similar to those of the embodiment 1.

1-21. (canceled)

22. A fuel cell system comprising:
a fuel cell;
a supply passage through which a fuel gas and an oxidizing gas is supplied to the fuel cell;
an exhaust passage through which the fuel gas and the oxidizing gas flow from the fuel cell;
a reactor that is provided in the exhaust passage and oxidizes a fuel off-gas from the fuel cell;
a bypass passage that extends from the supply passage to reach the reactor and returns to the supply passage, which receives a flow of at least a portion of the fuel gas and the oxidizing gas to be supplied to the fuel cell upon activation thereof so as to be heated under a heat generated in the reactor,
wherein the bypass passage comprises a fuel gas bypass passage and an oxidizing gas bypass passage, the fuel gas bypass passage is branched from the supply passage through which the fuel gas is supplied to the fuel cell to pass through the reactor and return to the supply passage such that a hydrogen rich gas flows therethrough, and the oxidizing gas bypass passage is branched from the supply passage through which the oxidizing gas is supplied to the fuel cell to pass through the reactor and return to the supply passage such that an oxygen rich gas flows therethrough.

23. The fuel cell system according to claim 22, wherein the reactor comprises at least one of a first reactor that allows the hydrogen rich gas to flow from the reactor into an anode of the fuel cell upon activation thereof, a second reactor that allows the oxygen rich gas to flow from the reactor into a cathode of the fuel cell.

24. The fuel cell system according to claim 22, further comprising: valves in the bypass passage and in the supply passage through which the fuel gas and the oxidizing gas are supplied to the fuel cell, wherein the valves are operated to select a state between a first state where at least a portion of the fuel gas and the oxidizing gas supplied to the fuel cell upon activation thereof passes through the bypass passage and the reactor, and a second state where at least a portion of the fuel gas and the oxidizing gas discharged from the fuel cell during a normal operation after the activation of the fuel cell passes through the reactor.

25. The fuel cell system according to claim 22, wherein a gas supplied to the reactor upon activation of the fuel cell is identical to a gas to be supplied to a gas inlet of the fuel cell during a normal operation thereof.

26. The fuel cell system according to claim 22, wherein the bypass passage is communicated with an inside of the reactor such that the gas flowing into the reactor upon activation of the fuel cell is heated and humidified in a reaction generated in the reactor and supplied to the fuel cell.

27. The fuel cell system according to claim 26, wherein:
the bypass passage comprises a fuel gas bypass passage and an oxidizing gas bypass passage;
the reactor comprises a first reactor that discharges the hydrogen rich gas so as to flow into the anode of the fuel cell upon activation thereof, and a second reactor that discharges the oxygen rich gas so as to flow into the cathode of the fuel cell upon activation thereof; and
the valve provided in the supply passage through which the fuel gas and the oxygen gas are supplied to the fuel cell comprises an on-off valve that allows a whole quantity of the fuel gas to flow into the first reactor and a whole quantity of the oxidizing gas into the second reactor upon activation of the fuel cell.

28. The fuel cell system according to claim 27, wherein:
the bypass passage comprises the fuel gas bypass passage and the oxidizing gas bypass passage; the reactor comprises the first reactor that discharges the hydrogen rich gas so as to flow into the anode of the fuel cell upon activation thereof, and the second reactor that discharges the oxygen rich gas so as to flow into the cathode of the fuel cell upon activation thereof; and
the valve provided in the supply passage through which the fuel gas and the oxygen gas are supplied to the fuel cell comprises a flow control valve that allows a portion of the fuel gas to flow into the first reactor, and a portion of the oxidizing gas into the second reactor upon activation of the fuel cell.

29. The fuel cell system according to claim 26, wherein:
the bypass passage (14) comprises an oxidizing gas bypass passage;
the reactor comprises the second reactor that discharges the oxygen rich gas to flow into the cathode of the fuel cell upon activation thereof; and
the valve provided in the supply passage through which the oxidizing gas is supplied to the fuel cell allows at least a portion of the oxidizing gas to flow into the second reactor upon activation of the fuel cell.

30. The fuel cell system according to claim 26, wherein:
the bypass passage comprises a fuel gas bypass passage;
the reactor comprises the first reactor (13A) that discharges the hydrogen rich gas to flow into the anode of the fuel cell upon activation thereof; and
the valve provided in the supply passage through which the fuel gas is supplied to the fuel cell allows at least a portion of the fuel gas to flow into the first reactor upon activation of the fuel cell.

31. The fuel cell system according to claim 22, wherein the bypass passage is arranged to be outside of the reactor so as not to be communicated with the inside of the reactor, and structured such that the heat is exchangeable between the bypass passage and the inside of the reactor.

32. A method of controlling a fuel cell system as claimed in claim 22, wherein at least a portion of the fuel gas and the oxidizing gas to be supplied to the fuel cell is fed into the bypass passage upon activation of the fuel cell so as to be heated under a heat generated in the reactor, and
wherein the bypass passage includes a fuel gas bypass passage and an oxidizing gas bypass passage, a hydrogen rich gas is supplied to the fuel gas bypass passage, and an oxygen rich gas is supplied to the oxidizing gas bypass passage.

33. The method according to claim 31, the reactor of the fuel cell system including at least one of a first reactor and a second reactor, wherein a hydrogen rich gas is supplied from the first reactor into an anode of the fuel cell upon activation thereof, and an oxygen rich gas is supplied from the second reactor into a cathode of the fuel cell.

34. The method according to claim 31, wherein an operation state of the fuel cell system is selected between a first state where at least a portion of the fuel gas and the oxidizing gas supplied to the fuel cell upon activation thereof passes through the bypass passage and the reactor, and a second state where at least a portion of the fuel gas and the oxidizing gas discharged from the fuel cell (10) during a normal operation after the activation of the fuel cell passes through the reactor.

35. The method according to claim 31, wherein a gas identical to that supplied to the reactor upon activation of the fuel cell is supplied to a gas inlet of the fuel cell during a normal operation thereof.

36. The method according to claim 31, the fuel cell system including the bypass passage communicated with an inside of the reactor, wherein the gas flowing into the reactor upon activation of the fuel cell is heated and humidified in a reaction generated in the reactor and supplied to the fuel cell.

37. The method according to claim 36, the bypass passage of the fuel cell system including a fuel gas bypass passage and an oxidizing gas bypass passage, and the reactor of the fuel cell system including a first reactor and a second reactor, wherein:
a whole quantity of the fuel gas is supplied to the first reactor; and
a whole quantity of the oxidizing gas is supplied to the second reactor upon activation of the fuel cell.

38. The method according to claim 36, the bypass passage of the fuel cell system including the fuel gas bypass passage and the oxidizing gas bypass passage, and the reactor of the fuel cell system including the first reactor and the second reactor, wherein:
a portion of the fuel gas is supplied to the first reactor; and
a portion of the oxidizing gas is supplied to the second reactor upon activation of the fuel cell.

39. The method according to claim 36, the bypass passage of the fuel cell system including an oxidizing gas bypass passage, and the reactor including the second reactor, wherein at least a portion of the oxidizing gas is supplied to the second reactor upon activation of the fuel cell.

40. The method according to claim 36, the bypass passage of the fuel cell system including a fuel gas bypass passage, and the reactor including the first reactor, wherein at least a portion of the fuel gas is supplied to the first reactor upon activation of the fuel cell.
